(19) United States
(12) Patent Application Publication
(10) Pub. No.: US 2005/0220454 A1
(43) Pub. Date: Oct. 6, 2005

(54) Optical transmission system

(75) Inventor: Hideki Okuno, Tokyo (JP)

Correspondence Address: Paul J. Esatton, Jr.;Scully, Scott, Murphy & Presser, 400 Garden City Plaza, Garden City, NY, 11530, US

(73) Assignee: NEC Corporation, Tokyo (JP)

(21) Appl. No.: 11/093,475

(22) Filed: Mar. 30, 2005

(30) Foreign Application Priority Data
Mar. 31, 2004 (JP) 105690/2004

(51) Int. Cl. H04B 10/08

(52) U.S. Cl. 398/30

(57) ABSTRACT

An optical transmission system capable of immediately stopping optical equipment which may emit a high-power output optical signal from the breaking point of a transmission line fiber. A control circuit has the first function of controlling an optical amplifier based on an optical supervisory channel received by an optical supervisory channel receiver. In addition, the control circuit has the second function of determining that the breaking of an optical fiber or the like has occurred when the strength of an optical supervisory channel received by an optical supervisory channel receiver is equal to or lower than a prescribed level and terminating the transmission of an optical signal through a line via the optical amplifier. With the second function, it is possible to prevent the emission of a high-power output optical signal from the breaking point of the optical fiber.

### FIELD OF THE INVENTION

The present invention relates to an optical transmission system comprising transmission line fibers for transmitting optical signals and optical supervisory channels, and relay stations placed thereon.

### BACKGROUND OF THE INVENTION

FIG. 1 is a diagram showing the construction of an example of a conventional optical transmission system. In the following, the conventional optical transmission system will be described referring to FIG. 1.

As can be seen in FIG. 1, an optical transmission system 50 comprises transmission line fibers 51 and relay stations A and B placed on the transmission line fibers 51. The transmission line fibers 51 transmit optical signals S1 and S2 in opposite directions as well as transmitting optical supervisory channels O1 and O2 in opposite directions. The transmission line fibers 51 include an up line L1 and a down line L2. The up line L1 transmits the optical signal S1 and the optical supervisory channel O1 in the same direction. The down line L2 transmits the optical signal S2 and the optical supervisory channel O2 in the same direction. That is, the optical signal S1 and the optical supervisory channel O1 are transmitted in the opposite direction of transmission of the optical signal S2 and the optical supervisory channel O2. The relay station A includes a relay section 521 set on the up line L1 side and a relay section 522 set on the down line L2 side.

The relay section 521 is provided with an optical amplifier 531, an optical supervisory channel demultiplexer 541, an optical supervisory channel receiver 551, a control circuit 561, an optical supervisory channel transmitter 571, and an optical supervisory channel multiplexer 581.

The optical amplifier 531 is placed on the up line L1 to input and output the optical signal S1. The optical supervisory channel demultiplexer 541 is placed on the input side of the optical amplifier 531 to separate out the optical supervisory channel O1. The optical supervisory channel receiver 551 receives the optical supervisory channel O1 separated out by the optical supervisory channel demultiplexer 541. The control circuit 561 controls the optical amplifier 531 based on the optical supervisory channel O1 received by the optical supervisory channel receiver 551. The optical supervisory channel transmitter 571 transmits the optical supervisory channel O1. The optical supervisory channel multiplexer 581 is placed on the output side of the optical amplifier 531 to combine the optical supervisory channel O1 transmitted from the optical supervisory channel transmitter 571 with the output.

The relay section 522 is provided with an optical amplifier 532, an optical supervisory channel demultiplexer 542, an optical supervisory channel receiver 552, a control circuit 562, an optical supervisory channel transmitter 572, and an optical supervisory channel multiplexer 582.

The optical amplifier 532 is placed on the down line L2 to input and output the optical signal S2. The optical supervisory channel demultiplexer 542 is placed on the input side of the optical amplifier 532 to separate out the optical supervisory channel O2. The optical supervisory channel receiver 552 receives the optical supervisory channel O2 separated out by the optical supervisory channel demultiplexer 542. The control circuit 562 controls the optical amplifier 532 based on the optical supervisory channel O2 received by the optical supervisory channel receiver 552. The optical supervisory channel transmitter 572 transmits the optical supervisory channel O2. The optical supervisory channel multiplexer 582 is placed on the output side of the optical amplifier 532 to combine the optical supervisory channel O2 transmitted from the optical supervisory channel transmitter 572 with the output.

The relay stations A and B are of like construction, and numbers with the same last two digits are utilized in designating corresponding portions of them.

Next, a description will be given of the operation of the optical transmission system 50.

Incidentally, the relay sections 521, 522, 621 and 622 operate in the same manner and thus but one of them, the relay section 521 located in the upper left portion of FIG. 1, will be described.

First, the optical supervisory channel demultiplexer 541 separates the optical supervisory channel O1 from the optical signal S1 transmitted from the preceding stage (not shown), and sends the signal O1 to the optical supervisory channel receiver 551. Having received the optical supervisory channel O1, the optical supervisory channel receiver 551 provides the control circuit 561 with information such as control parameters (information on the conditions for controlling the relay section 521 and the optical amplifier 531) included in the signal O1. Based on the control parameters, the control circuit 561 controls the optical amplifier 531 to receive the result of the control therefrom through a monitor. The optical supervisory channel transmitter 571 transmits the optical supervisory channel O1, to which the control circuit 561 has added new information. The optical supervisory channel multiplexer 581 combines the optical supervisory channel O1 with the optical signal S1 to transmit them to the next stage. As just described, the relay section 521 operates by remote control according to the optical supervisory channel O1.

The optical transmission system 50, however, has no function of shutting down optical equipment at the time of breaking of an optical fiber. Meanwhile, there have been known optical transmission systems having a function of stopping optical equipment at the time of breaking of an optical fiber. For example, in Japanese Patent Application laid open No. 2000-286798, there is disclosed such a technique.

FIG. 2 is a diagram showing the construction of another example of a conventional optical transmission system. In the following, the conventional optical transmission system will be described referring to FIG. 2. The conventional optical transmission system has a function of shutting down optical equipment at the time of breaking of an optical fiber in addition to the basic functions of the optical transmission system 50. Hereinafter, the additional function will be mainly described.

In FIG. 2, optical amplifiers 11a, 11b, 12a and 12b are erbium-doped fiber optical amplifiers, and amplify optical signals of 80 channels wavelength division multiplexed in the wavelength range of about 1574 to 1609 nm to output an optical signal of about +24 dBm. An optical supervisory channel transmitter 21a is an interface module equipped with a semiconductor laser diode. The optical supervisory channel transmitter 21a transmits electrical information for supervisory control of a transmission system (LINE-1) including the optical amplifiers 11a and 11b, and outputs an optical supervisory channel of around +5 dBm with a wavelength of about 1625 nm by one channel. An optical supervisory channel transmitter 22a is an interface module equipped with a semiconductor laser diode. The optical supervisory channel transmitter 22a transmits electrical information for supervisory control of a transmission system (LINE-2) including the optical amplifiers 12a and 12b, and outputs an optical supervisory channel of around +5 dBm with a wavelength of about 1625 nm by one channel. In other words, the optical signals and the optical supervisory channels are transmitted in the same directions, up or down, over the same optical fibers. Optical supervisory channel receivers 31b and 32b are interface modules, each of which is equipped with a photodiode and receives electrical information transmitted by the optical supervisory channel. An input optical signal monitor 41b is a photodiode for detecting an input optical signal. An optical multiplexer/demultiplexer 5 is a micro-optics type passive optical component for multiplexing/demultiplexing the optical signal and the optical supervisory channel. Optical fibers 61a and 62a are dispersion-shifted fibers (DSF) of about 80 km with a loss of about 20 dB/km.

For example, if the breaking or disconnection of the optical fiber 61a occurs at a point about 4 dB from the optical amplifier 11a, an optical signal is reduced in level from +24 to +20 dBm due to a loss of 4 dB. Thus, the optical signal with a level of +20 dBm is emitted from the breaking point of the optical fiber 61a. In such a case, it is desired to stop the optical amplifier 11a immediately. When the breaking of the optical fiber 61a occurs, an optical signal cannot be transmitted. As a result, the input optical signal monitor 41b is shortly to detect no input optical signal. The optical supervisory channel transmitter 22a transmits information that an input optical signal has not been detected as electrical information via a control circuit 7b. The information is transmitted through the optical fiber 62a, and received by the optical supervisory channel receiver 32b. Thereby, a control circuit 7a stops the operation of the optical amplifier 11a.

In this conventional optical transmission system, however, control of optical equipment for the breaking of an optical fiber, etc. is performed through an optical supervisory channel transmission system. Therefore, it is not possible to immediately stop optical equipment which may emit a high-power output optical signal from the point where breaking or the like has occurred.

### SUMMARY OF THE INVENTION

It is therefore an object of the present invention to provide an optical transmission system capable of immediately stopping optical equipment which may emit a high-power output optical signal from the point where breaking or the like has occurred.

In accordance with the first aspect of the present invention, to achieve the object mentioned above, there is provided an optical transmission system comprising transmission line fibers for transmitting first and second optical signals in opposite directions as well as transmitting first and second optical supervisory channels in opposite directions, and control means provided to the transmission line fibers. The transmission line fibers include first and second lines. The first line transmits the first optical signal and the second optical supervisory channel in opposite directions. The second line transmits the second optical signal and the first optical supervisory channel in opposite directions. The control means controls the first optical signal transmitted through the first line and the second optical signal transmitted through the second line based on the first optical supervisory channel transmitted through the second line and the second optical supervisory channel transmitted through the first line. Examples of the control means include relay stations placed on the transmission line fibers. The control means may be provided to either or both of two transmitting/receiving stations connected by the transmission line fibers. In the following, a description will be given of the case where relay stations serve as the control means.

The first optical signal and the second optical supervisory channel are transmitted through the first line in opposite directions. The second optical signal and the first optical supervisory channel are transmitted through the second line in opposite directions. Since the first and second optical signals are transmitted in opposite directions, the first optical signal and the first optical supervisory channel are transmitted in the same direction through the different lines. That is, as in the conventional optical transmission system 50, the first optical signal can be controlled based on the first optical supervisory channel. Besides, through the first line, the second optical supervisory channel is transmitted from the direction in which the first optical signal travels. That is, the first optical signal can be controlled based on the second optical supervisory channel. For example, when the intensity or strength of the second optical supervisory channel is equal to or lower than a prescribed level, it can be determined that breaking or the like has occurred in the first line in the direction of travel of the first optical signal. In this case, it is possible to prevent the emission of a high-power output optical signal from the breaking point by terminating the transmission of the first optical signal. Additionally, in this case, the transmission of the first optical signal can be terminated at a relay station in the stage preceding the first line by terminating the transmission of the second optical supervisory channel through the first line.

Similarly, the second optical signal transmitted through the second line can be controlled based on the first and second optical supervisory channels transmitted through the second and first lines.

The relay station may include a first relay section set on the first line side and a second relay section set on the second line side. In this case, the first relay section controls the first optical signal transmitted through the first line based on the first and second optical supervisory channels transmitted through the second and first lines, while the second relay section controls the second optical signal transmitted through the second line based on the first and second optical supervisory channels transmitted through the second and first lines. For example, when the intensity or strength of the second optical supervisory channel transmitted through the first line is equal to or lower than a prescribed level, the first relay section terminates the transmission of the first optical signal through the first line, and if necessary, terminates the transmission of the second optical supervisory channel through the first line. When the intensity or strength of the first optical supervisory channel transmitted through the second line is equal to or lower than a prescribed level, the second relay section terminates the transmission of the second optical signal through the second line, and if necessary, terminates the transmission of the first optical supervisory channel through the second line.

The first relay section may include first optical equipment placed on the first line for inputting and outputting the first optical signal, a second optical supervisory channel demultiplexer placed on the output side of the first optical equipment for separating out the second optical supervisory channel, a second optical supervisory channel receiver for receiving the second optical supervisory channel separated out by the second optical supervisory channel demultiplexer, a first control circuit for controlling the first optical equipment, a second optical supervisory channel transmitter for transmitting the second optical supervisory channel, and a second optical supervisory channel multiplexer placed on the input side of the first optical equipment for combining the second optical supervisory channel transmitted from the second optical supervisory channel transmitter with the output.

The second relay section may include second optical equipment placed on the second line for inputting and outputting the second optical signal, a first optical supervisory channel demultiplexer placed on the output side of the second optical equipment for separating out the first optical supervisory channel, a first optical supervisory channel receiver for receiving the first optical supervisory channel separated out by the first optical supervisory channel demultiplexer, a second control circuit for controlling the second optical equipment, a first optical supervisory channel transmitter for transmitting the first optical supervisory channel, and a first optical supervisory channel multiplexer placed on the input side of the second optical equipment for combining the first optical supervisory channel transmitted from the first optical supervisory channel transmitter with the output.

In this case, the first control circuit controls the first optical equipment based on the first and second optical supervisory channels received by the first and second optical supervisory channel receivers, and transmits the first optical supervisory channel via the first optical supervisory channel transmitter. The second control circuit controls the second optical equipment based on the first and second optical supervisory channels received by the first and second optical supervisory channel receivers, and transmits the second optical supervisory channel via the second optical supervisory channel transmitter.

For example, when the intensity or strength of the second optical supervisory channel received by the second optical supervisory channel receiver is equal to or lower than a prescribed level, the first control circuit terminates the transmission of the first optical signal through the first line via the first optical equipment, and if necessary, terminates the transmission of the second optical supervisory channel through the first line via the second optical supervisory channel transmitter. When the intensity or strength of the first optical supervisory channel received by the first optical supervisory channel receiver is equal to or lower than a prescribed level, the second control circuit terminates the transmission of the second optical signal through the second line via the second optical equipment, and if necessary, terminates the transmission of the first optical supervisory channel through the second line via the first optical supervisory channel transmitter.

In other words, according to the present invention, in an optical transmission system including optical equipment with high-power output such as an optical amplifier, when the breaking of an optical fiber as a transmission line fiber or disconnection of an optical connector occurs, the optical equipment with high-power output can be stopped immediately to assure safety.

As is described above, in accordance with the present invention, the first optical signal and the first optical supervisory channel are transmitted in the same direction, while the second optical signal and the second optical supervisory channel are transmitted in the same direction. That is, a pair of the first optical signal and the first optical supervisory channel and a pair of the second optical signal and the second optical supervisory channel are transmitted in opposite directions. The first optical signal and the second optical supervisory channel are transmitted through the first line. The second optical signal and the first optical supervisory channel are transmitted through the second line. Thereby, the first and second optical signals can be controlled by the first and second optical supervisory channels as with conventional techniques. In addition, breaking or the like which has occurred in the direction of travel of the first and second optical signals can be detected by the second and first optical supervisory channels, respectively. Thus, the breaking of a transmission line fiber or the like is detected by the optical supervisory channel which propagates against the direction of travel of the optical signal, and therefore, it is possible to immediately stop optical equipment which may emit a high-power output optical signal from the point where breaking or the like has occurred. Furthermore, the optical transmission system of the present invention can be realized simply by rewiring a conventional system.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing the construction of an example of a conventional optical transmission system;

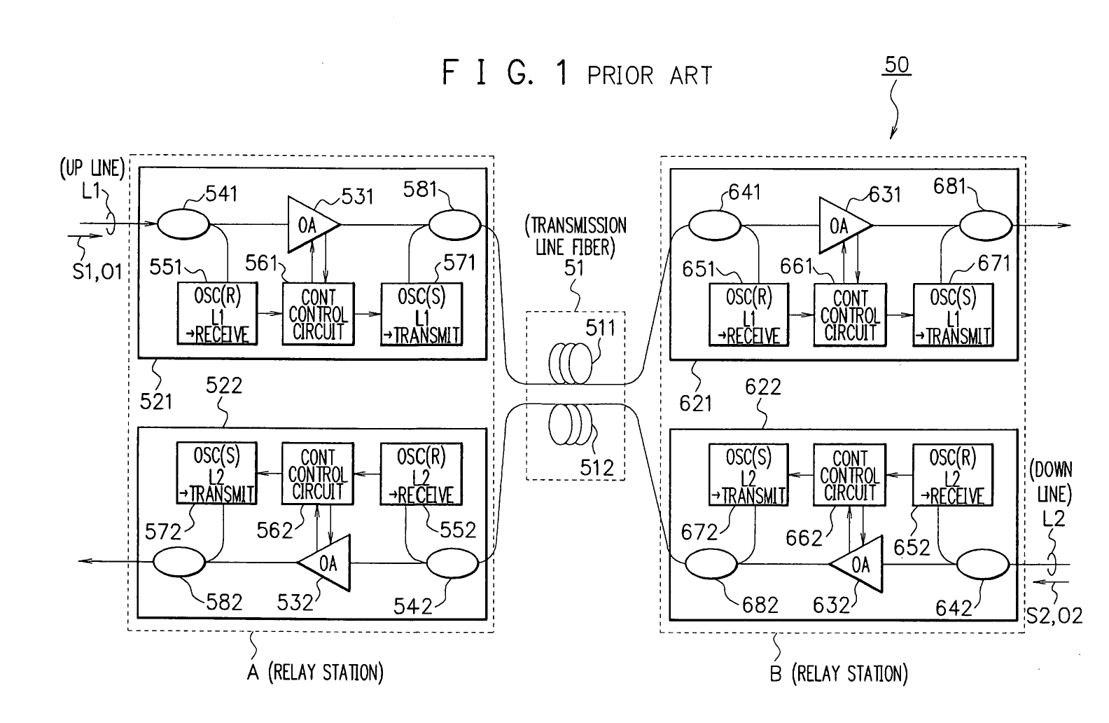

FIG. 2 is a diagram showing the construction of another example of a conventional optical transmission system;

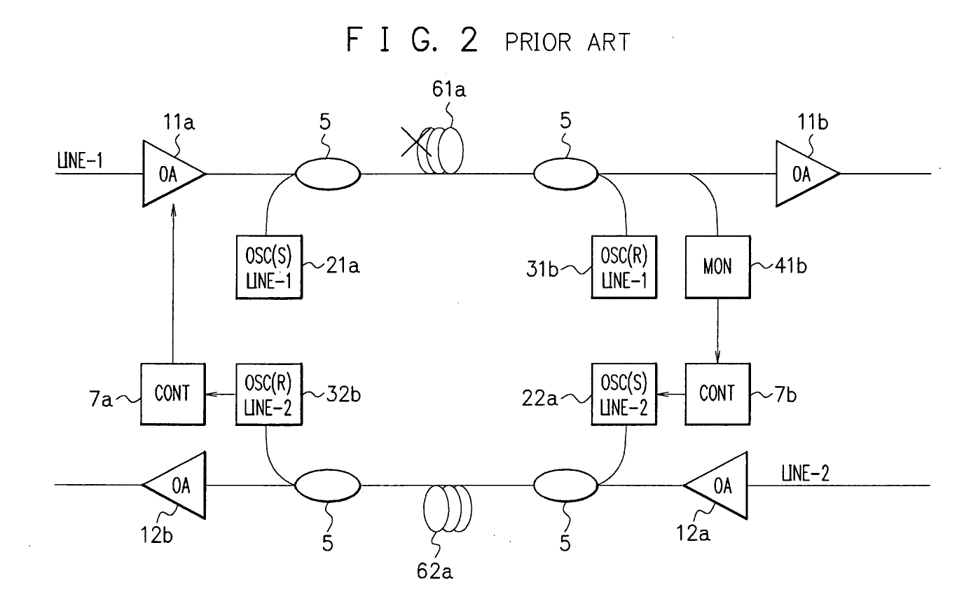

FIG. 3 is a diagram showing the construction of an optical transmission system according to the first embodiment of the present invention; and

FIG. 4 is a diagram showing the construction of an optical transmission system according to the second embodiment of the present invention.

### DESCRIPTION OF THE PREFERRED EMBODIMENTS

Referring now to the drawings, a description of preferred embodiments of the present invention will be given in detail.

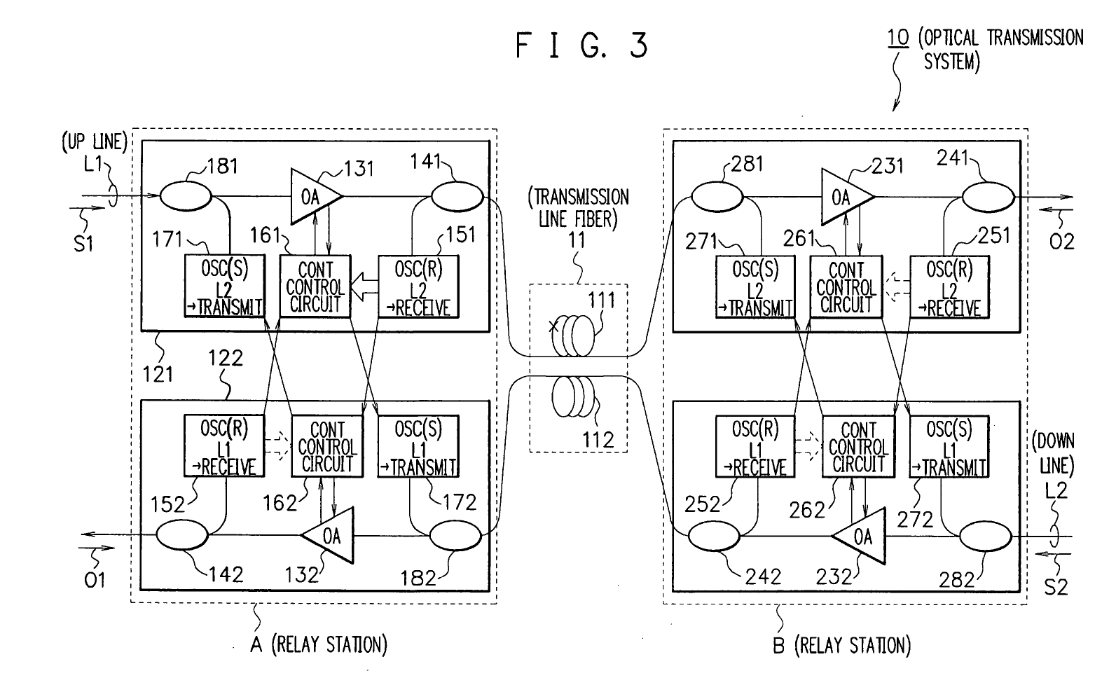

FIG. 3 is a diagram showing the construction of an optical transmission system according to the first embodiment of the present invention. In the following, the first embodiment of the present invention will be described referring to FIG. 3.

As can be seen in FIG. 3, an optical transmission system 10 comprises transmission line fibers 11 and relay stations A and B placed on the transmission line fibers 11. The transmission line fibers 11 transmit optical signals S1 and S2 in opposite directions as well as transmitting optical supervisory channels O1 and O2 in opposite directions. The transmission line fibers 11 include an up line L1 and a down line L2. The up line L1 transmits the optical signal S1 and the optical supervisory channel O2 in opposite directions. The down line L2 transmits the optical signal S2 and the optical supervisory channel O1 in opposite directions. The relay station A includes a relay section 121 set on the up line L1 side and a relay section 122 set on the down line L2 side.

The relay section 121 is provided with an optical amplifier 131, an optical supervisory channel demultiplexer 141, an optical supervisory channel receiver 151, a control circuit 161, an optical supervisory channel transmitter 171, and an optical supervisory channel multiplexer 181.

The optical amplifier 131 is placed on the up line L1 to input and output the optical signal S1. The optical supervisory channel demultiplexer 141 is placed on the output side of the optical amplifier 131 to separate out the optical supervisory channel O2. The optical supervisory channel receiver 151 receives the optical supervisory channel O2 separated out by the optical supervisory channel demultiplexer 141. The control circuit 161 controls the optical amplifier 131. The optical supervisory channel transmitter 171 transmits the optical supervisory channel O2. The optical supervisory channel multiplexer 181 is placed on the input side of the optical amplifier 131 to combine the optical supervisory channel O2 transmitted from the optical supervisory channel transmitter 171 with the output.

The relay section 122 is provided with an optical amplifier 132, an optical supervisory channel demultiplexer 142, an optical supervisory channel receiver 152, a control circuit 162, an optical supervisory channel transmitter 172, and an optical supervisory channel multiplexer 182.

The optical amplifier 132 is placed on the down line L2 to input and output the optical signal S2. The optical supervisory channel demultiplexer 142 is placed on the output side of the optical amplifier 132 to separate out the optical supervisory channel O1. The optical supervisory channel receiver 152 receives the optical supervisory channel O1 separated out by the optical supervisory channel demultiplexer 142. The control circuit 162 controls the optical amplifier 132. The optical supervisory channel transmitter 172 transmits the optical supervisory channel O1. The optical supervisory channel multiplexer 182 is placed on the input side of the optical amplifier 132 to combine the optical supervisory channel O1 transmitted from the optical supervisory channel transmitter 172 with the output.

The control circuit 161 controls the optical amplifier 131 based on the optical supervisory channels O1 and O2 received by the optical supervisory channel receivers 152 and 151, and transmits the optical supervisory channel O1 via the optical supervisory channel transmitter 172. The control circuit 162 controls the optical amplifier 132 based on the optical supervisory channels O1 and O2 received by the optical supervisory channel receivers 152 and 151, and transmits the optical supervisory channel O2 via the optical supervisory channel transmitter 171.

As with conventional techniques, the control circuit 161 has the first function of controlling the optical amplifier 131 based on the optical supervisory channel O1 received by the optical supervisory channel receiver 152. In addition, the control circuit 161 has the second function of determining that the breaking of an optical fiber (transmission line fiber) 111 or the like has occurred when the intensity or strength of the optical supervisory channel O2 received by the optical supervisory channel receiver 151 is equal to or lower than a prescribed level and terminating the transmission of the optical signal S1 through the up line L1 via the optical amplifier 131. With the second function, it is possible to prevent the emission of a high-power output optical signal from the breaking point of the optical fiber 111. The control circuits 162, 261 and 262 also have the first and second functions as with the control circuit 161.

Next, each component of the relay section 121 will be described.

The optical transmission system 10 is a WDM (Wavelength Division Multiplexing) transmission system. The optical amplifier 131 is an erbium-doped fiber optical amplifier, and amplifies optical signals of 80 channels wavelength division multiplexed in the wavelength range of about 1574 to 1609 nm to output the optical signal S1 of about +24 dBm. The optical supervisory channel transmitter 171 is a semiconductor laser diode. The optical supervisory channel transmitter 171 outputs the optical supervisory channel O2 of around +5 dBm with a wavelength of about 1625 nm by one channel. The optical supervisory channel receiver 151 is a photodiode, and detects the optical supervisory channel O2. The optical supervisory channel demultiplexer 141 and the optical supervisory channel multiplexer 181 are micro-optics type passive optical components for separating/combining the optical supervisory channel O2 from/with the optical signal S1. The optical fiber (transmission line fiber) 111 is a dispersion-shifted optical fiber of about 80 km with a loss of about 20 dB/km. The control circuit 161 has the conventional function of controlling the optical amplifier 131 based on the optical supervisory channel O1 received by the optical supervisory channel receiver 152 as well as the new function of immediately stopping the optical amplifier 131 when the optical supervisory channel receiver 151 detects no optical supervisory channel O2.

In the following, a description will be given of the operation of the optical transmission system 10.

For example, if the breaking of the transmission line fiber 111 occurs at a point about 4 dB from the optical amplifier 131, an optical signal is reduced in level from +24 to +20 dBm due to a loss of 4 dB. Thus, the optical signal with a level of +20 dBm will be emitted from the breaking point of the transmission line fiber 111. In such a case, it is desired to stop the optical amplifier 131 immediately. When the breaking of the transmission line fiber 111 occurs, the optical supervisory channel O2 from an optical supervisory channel transmitter 271 cannot be transmitted. Consequently, the optical supervisory channel receiver 151 is shortly to detect no optical supervisory channel O2, and thereby, the control circuit 161 stops the optical amplifier 131 immediately. As just described, in this embodiment, the breaking of the transmission line fiber 111 or the like is detected by the optical supervisory channel O2 which propagates against the direction of travel of the optical signal S1. Thus, it is possible to immediately stop the optical amplifier 131 which may emit a high-power output optical signal from the breaking point.

Next, a description will be given of the operation of the optical transmission system 10 in a different mode of expression. Incidentally, it is assumed that the optical supervisory channel demultiplexers 142 and 242 and the optical supervisory channel multiplexers 182 and 282 are WDM (Wavelength Division Multiplexing) couplers or the like.

The optical signal S1 transmitted through the up line L1 is input to the relay section 121 located in the upper left portion of FIG. 3, and amplified by the optical amplifier 131 of the relay station A. Subsequently, the optical signal S1 is transmitted through the transmission line fiber 111 to be amplified again by the optical amplifier 231 of the relay station B. Thereby, the optical signal S1 is output from the relay section 221 located in the upper right portion of FIG. 3.

Meanwhile, the optical signal S2 transmitted through the down line L2 is input to the relay section 222 located in the lower right portion of FIG. 3, and amplified by the optical amplifier 232 of the relay station B. After that, the optical signal S2 is transmitted through the transmission line fiber 112 to be amplified again by the optical amplifier 132 of the relay station A. Thereby, the optical signal S2 is output from the relay section 122 located in the lower left portion of FIG. 3.

On the other hand, the optical supervisory channel O1 or OSC (Optical Supervisory Channel) signal for controlling the optical amplifiers 131 and 231 placed on the up line L1 is input through the down line L2 to the relay section 122 located in the lower left portion of FIG. 3. Only the optical supervisory channel O1 is separated out by the optical supervisory channel demultiplexer 142 of the relay station A. The optical supervisory channel O1 is received by the optical supervisory channel receiver 152, and converted to an electrical signal. Then, the optical supervisory channel O1 is fed to the control circuit 161 to control the optical amplifier 131. Thereafter, the optical supervisory channel O1 is sent to the optical supervisory channel transmitter 172, and reconverted to an optical signal. The optical supervisory channel O1, which has been converted to an optical signal, is combined by the optical supervisory channel multiplexer 182 with the output to the down line L2, and transmitted through the transmission line fiber 112 to the relay station B. The relay station B operates in the same manner as described above for the relay station A.

Meanwhile, the optical supervisory channel O2 for controlling the optical amplifiers 132 and 232 placed on the down line L2 is input through the up line L1 to the relay section 221 located in the upper right portion of FIG. 3. Only the optical supervisory channel O2 is separated out by the optical supervisory channel demultiplexer 241 of the relay station B. The optical supervisory channel O2 is received by the optical supervisory channel receiver 251, and converted to an electrical signal. Then, the optical supervisory channel O2 is fed to the control circuit 262 to control the optical amplifier 232. Thereafter, the optical supervisory channel O2 is sent to the optical supervisory channel transmitter 271, and reconverted to an optical signal. The optical supervisory channel O2, which has been converted to an optical signal, is combined by the optical supervisory channel multiplexer 281 with the output to the up line L1, and transmitted through the transmission line fiber 111 to the relay station A. The relay station A operates in the same manner as described previously for the relay station B.

In the case where the breaking of the transmission line fiber 111 or the like occurs when the optical signal S1 is transmitted through the transmission line fiber 111 to the relay station B in the up line L1, the optical supervisory channel O2, which is supposed to be transmitted from the relay station B to A through the transmission line fiber 111, is not detected by the optical supervisory channel receiver 151 of the relay station A. When the optical supervisory channel receiver 151 supplies the control circuit 161 with this information, the control circuit 161 terminates the operation of the optical amplifier 131. Thus, the optical amplifier 131 placed on the up line L1 can be stopped immediately. In addition, it is possible to prevent leakage of a high-power optical signal from the breaking point of the optical fiber 111.

As is described above, in the optical transmission system 10, an optical signal and an OSC signal are transmitted in the same direction through opposing lines differently from conventional systems in which they are transmitted in the same direction over the same line. Further, with the use of the OSC signal, an optical amplifier on the transmitting side can be stopped immediately when breaking or the like has occurred.

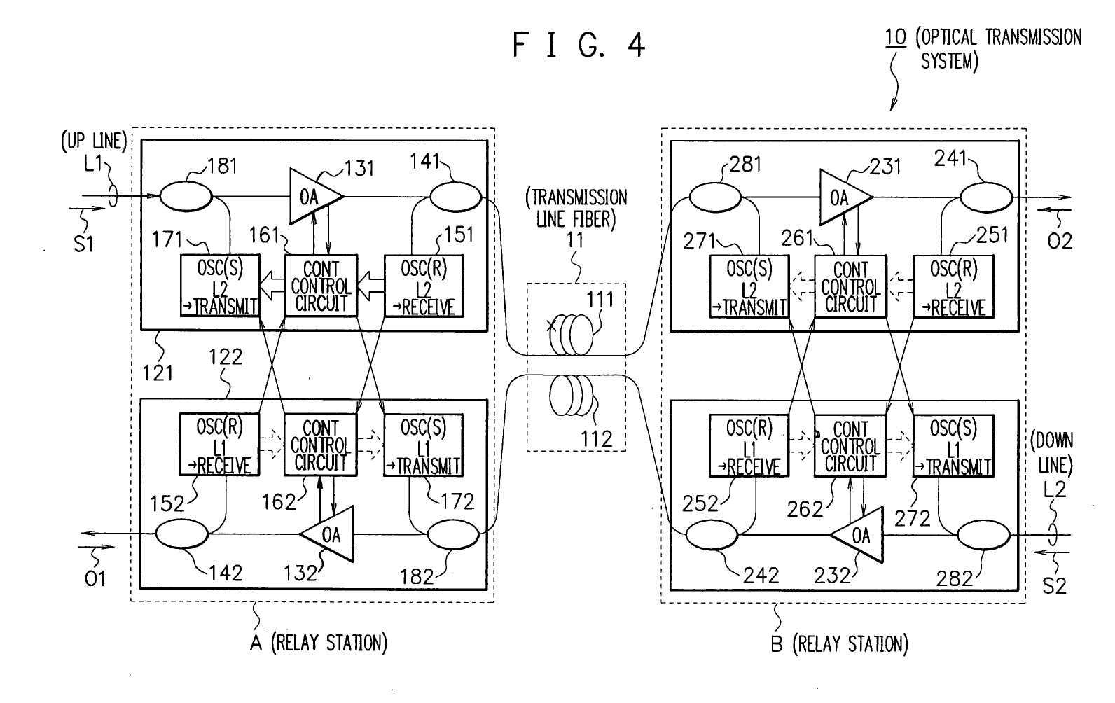

FIG. 4 is a diagram showing the construction of an optical transmission system according to the second embodiment of the present invention. In the following, the second embodiment of the present invention will be described referring to FIG. 4. Since the optical transmission system shown in FIG. 4 is in many respects basically similar to that of FIG. 3, like numerals are utilized in designating corresponding portions of the system and the detailed description will not be repeated here.

The control circuit 161 has the third function of, when the intensity or strength of the optical supervisory channel O2 received by the optical supervisory channel receiver 151 is equal to or lower than a prescribed level, terminating the transmission of the optical supervisory channel O2 through the up line L1 via the optical supervisory channel transmitter 171. In this case, the transmission of the optical signal S1 can be terminated at a relay station (not shown) in the stage preceding the up line L1. Incidentally, the control circuit 162 may have a function similar to the third function.

In the case where the breaking of the transmission line fiber 111 or the like occurs, the optical supervisory channel O2 transmitted from the optical supervisory channel transmitter 271 is not detected by the optical supervisory channel receiver 151. On this occasion, the control circuit 161 immediately terminates the transmission of the optical supervisory channel O2 from the optical supervisory channel transmitter 171.

As is described above, in the second embodiment, when having detected no optical supervisory channel O2, the relay station A terminates the transmission of the optical supervisory channel O2 to the preceding stage. Thus, it becomes possible to immediately stop all optical amplifiers with high-power output in the stage preceding the point where the breaking of the transmission line fiber 111 or the like has occurred.

Incidentally, the components, wavelengths, wavebands and signal levels have been cited merely by way of example and without limitation. Especially, the optical amplifier 131 may be an optical amplifier other than an erbium-doped fiber optical amplifier, an optical transmitter, a variable optical attenuator (VOA), a gate switch (GS), or the like.

As set forth hereinabove, in accordance with the present invention, an optical signal and an optical supervisory channel are transmitted in the same direction through different lines. Besides, an optical signal and an optical supervisory channel are transmitted in opposite directions over the same line. Thereby, the optical signal can be controlled by the optical supervisory channel. In addition, the breaking of a transmission line fiber or the like can be detected by the optical supervisory channel transmitted in the opposite direction of travel of the optical signal. Thus, it is possible to immediately stop optical equipment, such as an optical amplifier, which may emit a high-power output optical signal from the point where breaking or the like has occurred.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An optical transmission system comprising transmission line fibers for transmitting first and second optical signals in opposite directions as well as transmitting first and second optical supervisory channels in opposite directions, and control means provided to the transmission line fibers, wherein:
the transmission line fibers include first and second lines;
the first line transmits the first optical signal and the second optical supervisory channel in opposite directions;
the second line transmits the second optical signal and the first optical supervisory channel in opposite directions; and
the control means controls the first optical signal transmitted through the first line and the second optical signal transmitted through the second line based on the first optical supervisory channel transmitted through the second line and the second optical supervisory channel transmitted through the first line.

2. The optical transmission system claimed in claim 1, wherein:
when the strength of the second optical supervisory channel transmitted through the first line is equal to or lower than a prescribed level, the control means terminates the transmission of the first optical signal through the first line; and
when the strength of the first optical supervisory channel transmitted through the second line is equal to or lower than a prescribed level, the control means terminates the transmission of the second optical signal through the second line.

3. The optical transmission system claimed in claim 2, wherein:
when the strength of the second optical supervisory channel transmitted through the first line is equal to or lower than a prescribed level, the control means terminates the transmission of the second optical supervisory channel through the first line; and
when the strength of the first optical supervisory channel transmitted through the second line is equal to or lower than a prescribed level, the control means terminates the transmission of the first optical supervisory channel through the second line.

4. The optical transmission system claimed in claim 1, wherein the control means is a relay station provided to the transmission line fiber.

5. The optical transmission system claimed in claim 4, wherein:
the relay station include a first relay section set on the first line side and a second relay section set on the second line side;
the first relay section controls the first optical signal transmitted through the first line based on the first and second optical supervisory channels transmitted through the second and first lines; and
the second relay section controls the second optical signal transmitted through the second line based on the first and second optical supervisory channels transmitted through the second and first lines.

6. The optical transmission system claimed in claim 5, wherein:
when the strength of the second optical supervisory channel transmitted through the first line is equal to or lower than a prescribed level, the first relay section terminates the transmission of the first optical signal through the first line; and
when the strength of the first optical supervisory channel transmitted through the second line is equal to or lower than a prescribed level, the second relay section terminates the transmission of the second optical signal through the second line.

7. The optical transmission system claimed in claim 6, wherein:
when the strength of the second optical supervisory channel transmitted through the first line is equal to or lower than a prescribed level, the first relay section terminates the transmission of the second optical supervisory channel through the first line; and
when the strength of the first optical supervisory channel transmitted through the second line is equal to or lower than a prescribed level, the second relay section terminates the transmission of the first optical supervisory channel through the second line.

8. The optical transmission system claimed in claim 5, wherein:
the first relay section includes first optical equipment placed on the first line for inputting and outputting the first optical signal, a second optical supervisory channel demultiplexer placed on the output side of the first optical equipment for separating out the second optical supervisory channel, a second optical supervisory channel receiver for receiving the second optical supervisory channel separated out by the second optical supervisory channel demultiplexer, a first control circuit for controlling the first optical equipment, a second optical supervisory channel transmitter for transmitting the second optical supervisory channel, and a second optical supervisory channel multiplexer placed on the input side of the first optical equipment for combining the second optical supervisory channel transmitted from the second optical supervisory channel transmitter with the output;
the second relay section includes second optical equipment placed on the second line for inputting and outputting the second optical signal, a first optical supervisory channel demultiplexer placed on the output side of the second optical equipment for separating out the first optical supervisory channel, a first optical supervisory channel receiver for receiving the first optical supervisory channel separated out by the first optical supervisory channel demultiplexer, a second control circuit for controlling the second optical equipment, a first optical supervisory channel transmitter for transmitting the first optical supervisory channel, and a first optical supervisory channel multiplexer placed on the input side of the second optical equipment for combining the first optical supervisory channel transmitted from the first optical supervisory channel transmitter with the output;
the first control circuit controls the first optical equipment based on the first and second optical supervisory channels received by the first and second optical supervisory channel receivers, and transmits the first optical supervisory channel via the first optical supervisory channel transmitter; and
the second control circuit controls the second optical equipment based on the first and second optical supervisory channels received by the first and second optical supervisory channel receivers, and transmits the second optical supervisory channel via the second optical supervisory channel transmitter.

9. The optical transmission system claimed in claim 8, wherein:
when the strength of the second optical supervisory channel received by the second optical supervisory channel receiver is equal to or lower than a prescribed level, the first control circuit terminates the transmission of the first optical signal through the first line via the first optical equipment; and
when the strength of the first optical supervisory channel received by the first optical supervisory channel receiver is equal to or lower than a prescribed level, the second control circuit terminates the transmission of the second optical signal through the second line via the second optical equipment.

10. The optical transmission system claimed in claim 9, wherein:
when the strength of the second optical supervisory channel received by the second optical supervisory channel receiver is equal to or lower than a prescribed level, the first control circuit terminates the transmission of the second optical supervisory channel through the first line via the second optical supervisory channel transmitter; and
when the strength of the first optical supervisory channel received by the first optical supervisory channel receiver is equal to or lower than a prescribed level, the second control circuit terminates the transmission of the first optical supervisory channel through the second line via the first optical supervisory channel transmitter.

11. The optical transmission system claimed in claim 8, wherein the optical equipment is an optical amplifier.
